(19) United States
(12) Patent Application Publication
(10) Pub. No.: US 2026/0126840 A1
(43) Pub. Date: May 7, 2026

(54) CONTROL CIRCUIT FOR UNIVERSAL SERIAL BUS

(71) Applicant: Power Forest Technology Corporation, Hsinchu County (TW)

(72) Inventors: Chih Hsiang Chung, Hsinchu County (TW); Rong-Jie Tu, Hsinchu County (TW)

(73) Assignee: Power Forest Technology Corporation, Hsinchu County (TW)

(21) Appl. No.: 18/970,818

(22) Filed: Dec. 5, 2024

(30) Foreign Application Priority Data
Nov. 5, 2024 (TW) 113211999

(51) Int. Cl. G06F 1/26; G06F 13/42

(52) U.S. Cl. CPC G06F 1/266; G06F 13/4282; G06F 2213/0042

(57) ABSTRACT

A control circuit for a universal serial bus (USB) is provided. The control circuit includes a blocking switch, a current source circuit, a discharge circuit, and a controller. The blocking switch is connected between a power supply terminal of the USB and a bus power terminal of the USB. Before supplying power to the bus power terminal, the controller turns off the blocking switch and controls the discharge circuit to pull down an output voltage value at the bus power terminal. When the output voltage value is lower than or equal to a set voltage value, the discharge circuit stops pulling down the output voltage value, and controls the current source circuit to provide a test current to the bus power terminal. The controller obtains a resistance value at the bus power terminal based on the output voltage value and a current value of the test current.

### CROSS-REFERENCE TO RELATED APPLICATION

This application claims the priority benefit of Taiwan application serial no. 113211999, filed on November 5, 2024. The entirety of the above-mentioned patent application is hereby incorporated by reference herein and made a part of this specification.

### BACKGROUND

### Technical Field

The disclosure relates to a control circuit, and particularly relates to a control circuit for a universal serial bus (USB).

### Description of Related Art

A universal serial bus (USB) includes a bus power terminal (Vbus) and a ground terminal (GND). When the USB is abnormal or incorrectly used, the bus power terminal and the ground terminal of the USB have an abnormal low resistance value. The low resistance value is, for example, tens of ohms (Ω). Such the abnormal low resistance value does not cause a short circuit between the bus power terminal and the ground terminal. However, the local thermal energy generated by the current based on the abnormal low resistance value is sufficient to damage the structure of the USB (such as the tongue plate of the USB). Besides, if a resistance value between the bus power terminal and a power receiving device is low, the normal low resistance value between the bus power terminal and a power receiving device may be judged as the abnormal low resistance value, so as to stop the USB providing a power to the power receiving device. Therefore, how to detect the resistance value at the bus power terminal is one of the issues that need to be worked on in this field.

### SUMMARY

The disclosure provides a control circuit for a universal serial bus (USB), which can detect the resistance value at the bus power terminal.

In an embodiment of the disclosure, a control circuit includes a blocking switch, a current source circuit, a discharge circuit, and a controller. The blocking switch is electrically connected between a power supply terminal of a USB and a bus power terminal of the USB. The current source circuit is electrically connected between the power supply terminal and the bus power terminal. The controller is electrically connected to a control terminal of the blocking switch, the current source circuit, and the discharge circuit. Before supplying power to the bus power terminal, the controller turns off the blocking switch, and controls the discharge circuit to pull down an output voltage value at the bus power terminal. In response to the output voltage value being lower than or equal to a first set voltage value, the controller controls the discharge circuit to stop pulling down the output voltage value, and controls the current source circuit to provide a test current to the bus power terminal. The controller obtains a resistance value at the bus power terminal according to the output voltage value and a current value of the test current.

In an embodiment of the disclosure, the current source circuit includes a first current source and a first switch. A first terminal of the first current source is electrically connected to the power supply terminal. The first current source generates the test current. The first switch is electrically connected between a second terminal of the first current source and the bus power terminal.

In an embodiment of the disclosure, the discharge circuit includes a second current source and a second switch. A first terminal of the second current source is electrically connected to the bus power terminal. The second current source generates a discharge current. The second switch is electrically connected between a second terminal of the second current source and a reference low voltage.

In an embodiment of the disclosure, before supplying power to the bus power terminal, the controller turns off the blocking switch, turns off the first switch, and turns on the second switch.

In an embodiment of the disclosure, in response to the output voltage value being lowered to the first set voltage value, the controller turns off the blocking switch, turns off the second switch, and turns on the first switch.

In an embodiment of the disclosure, during a period when the test current is provided to the bus power terminal, in response to the output voltage value being higher than a second set voltage value, the controller turns on the blocking switch.

In an embodiment of the disclosure, the control circuit further includes a comparator. The comparator is electrically connected to the bus power terminal and the controller. The comparator receives the output voltage value and the first set voltage value. Before supplying power to the bus power terminal, the comparator compares the output voltage value and the first set voltage value to generate a comparison signal.

In an embodiment of the disclosure, before supplying power to the bus power terminal, the controller receives the comparison signal. In response to the comparison signal indicating that the output voltage value is higher than the first set voltage value, the controller controls the discharge circuit to pull down the output voltage value, and controls the current source circuit to stop providing the test current to the bus power terminal.

In an embodiment of the disclosure, in response to the comparison signal indicating that the output voltage value is lower than or equal to the first set voltage value, the controller controls the discharge circuit to stop pulling down the output voltage value, and controls the current source circuit to provide the test current to the bus power terminal.

In an embodiment of the disclosure, the control circuit communicates with a power receiving device connected to the bus power terminal to obtain a communication resistance value. The communication resistance value is a resistance value at the bus power terminal when the bus power terminal is connected to the power receiving device. The controller determines whether to control the current source circuit to provide the test current to the bus power terminal according to the communication resistance value.

Based on the above, before supplying power to the bus power terminal, the controller controls the discharge circuit to pull down the output voltage value at the bus power terminal. When the output voltage value is lower than or equal to the first set voltage value, the controller controls the discharge circuit to stop pulling down the output voltage value, and controls the current source circuit to provide the test current to the bus power terminal. Therefore, the controller can obtain the resistance value at the bus power terminal according to the output voltage value and the current value of the test current. In this way, before supplying power to the bus power terminal, the control circuit can determine whether the bus power terminal has abnormal conditions such as low resistance value between the bus power terminal and the ground terminal according to the resistance value at the bus power terminal.

### BRIEF DESCRIPTION OF THE DRAWINGS

FIG. 1 is a schematic diagram of the control circuit according to an embodiment of the disclosure.

FIG. 2 is a schematic diagram of the control circuit according to an embodiment of the disclosure.

FIG. 3 is a schematic diagram of the control circuit according to an embodiment of the disclosure.

FIG. 4 is an operational schematic diagram of the control circuit according to an embodiment of the disclosure.

### DESCRIPTION OF THE EMBODIMENTS

Some embodiments of the disclosure will be described in detail with reference to the accompanying drawings. Regarding the reference numerals mentioned in the following description, the same reference numerals that appear in different drawings will be regarded as referring to identical or similar elements. These embodiments are only a part of the disclosure and do not disclose all possible implementations of the disclosure. More precisely, these embodiments are merely examples within the scope of the claims of the disclosure.

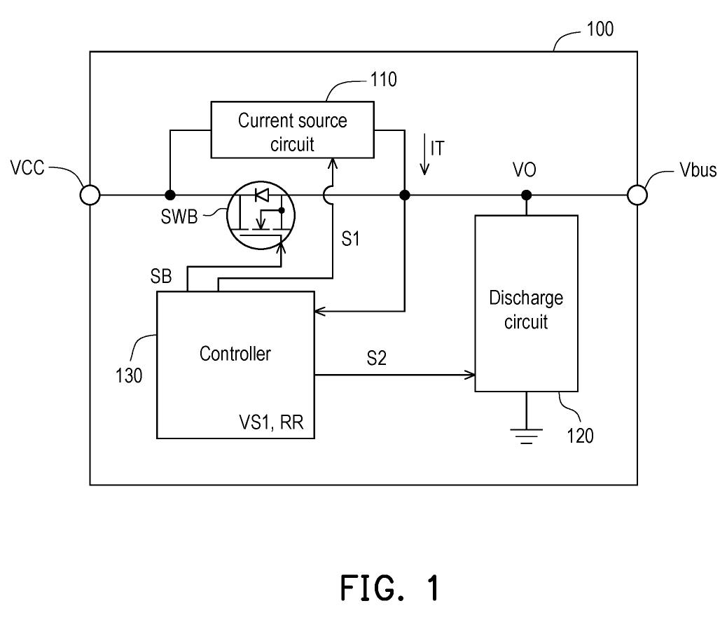

Referring to FIG. 1, FIG. 1 is a schematic diagram of the control circuit according to an embodiment of the disclosure. In this embodiment, a control circuit 100 is used for a universal serial bus (USB). The USB may be any version of bus including a power supply terminal VCC and a bus power terminal Vbus. The control circuit 100 includes a blocking switch SWB, a current source circuit 110, a discharge circuit 120, and a controller 130. The blocking switch SWB is electrically connected between the power supply terminal VCC of the USB and the bus power terminal Vbus of the USB. The current source circuit 110 is electrically connected between the power supply terminal VCC and the bus power terminal Vbus. The controller 130 is electrically connected to the control terminal of the blocking switch SWB, the current source circuit 110, and the discharge circuit 120. The controller 130 controls the blocking switch SWB, the current source circuit 110, and the discharge circuit 120 to perform a detection operation of a resistance value RR at the bus power terminal Vbus.

In this embodiment, the detection operation is performed before supplying power to the bus power terminal Vbus. For example, the detection operation may be performed during the period when the blocking switch SWB is turned off.

In this embodiment, before supplying power to the bus power terminal Vbus, the controller 130 turns off the blocking switch SWB, and controls the discharge circuit 120 to pull down an output voltage value VO at the bus power terminal Vbus. When the output voltage value VO is pulled down to be lower than or equal to a set voltage value VS1, the controller 130 controls the discharge circuit 120 to stop pulling down the output voltage value VO, and controls the current source circuit 110 to provide a test current IT to the bus power terminal Vbus. The controller 130 obtains the resistance value RR at the bus power terminal Vbus according to the output voltage value VO and the current value of the test current IT.

In this embodiment, the resistance value RR at the bus power terminal Vbus may be the quotient of the output voltage value VO divided by the current value of the test current IT. The controller 130 determines whether abnormal conditions such as low resistance value or short circuit occur at the bus power terminal Vbus according to the resistance value RR at the bus power terminal Vbus.

It is worth mentioning here that before supplying power to the bus power terminal Vbus, the discharge circuit 120 pulls down the output voltage value VO at the bus power terminal Vbus. When the output voltage value VO is pulled down to be lower than or equal to the set voltage value VS1, the discharge circuit 120 stops pulling down the output voltage value VO. The current source circuit 110 provides the test current IT to the bus power terminal Vbus. The controller 130 obtains the resistance value RR at the bus power terminal Vbus according to the output voltage value VO and the current value of the test current IT. Thus, before supplying power to the bus power terminal Vbus, the control circuit 100 determines whether abnormal conditions such as low resistance value or short circuit occur at the bus power terminal Vbus according to the resistance value RR at the bus power terminal Vbus.

For example, the set voltage value VS1 may be 0.8 volts (V), but the disclosure is not limited thereto. The test current IT is a constant current. The current value of the test current IT may be 1 milliampere (mA), but the disclosure is not limited thereto. The output voltage value VO may be 0.8 V, but the disclosure is not limited thereto. Therefore, the resistance value RR at the bus power terminal Vbus is approximately equal to 800 ohms (Ω).

Generally speaking, current detection technology can detect whether a short circuit occurs at the bus power terminal Vbus, but does not detect whether there is a low resistance value at the bus power terminal Vbus. Such a low resistance value may be, for example, tens of ohms (Ω). The low resistance value does not cause a short circuit between the bus power terminal Vbus and the ground terminal. However, during the period of supplying power to the bus power terminal Vbus, the local thermal energy generated by the current resulting from the low resistance value is sufficient to damage the structure of the USB (such as the tongue plate of the USB). It should be noted that the aforementioned low resistance value cannot be detected by current detection technology. The control circuit 100 of this embodiment is capable of determining whether the bus power terminal Vbus has a low resistance value. Therefore, the control circuit 100 can provide protection or warning according to the resistance value RR at the bus power terminal Vbus.

In this embodiment, the blocking switch SWB is implemented by a field-effect transistor. However, the disclosure is not intended to limit the form of the blocking switch SWB. The blocking switch SWB of the disclosure may be implemented by at least one transistor of any type.

In this embodiment, the controller 130 uses a control signal SB to control the blocking switch SWB, uses a control signal S1 to control the current source circuit 110, and uses a control signal S2 to control the discharge circuit 120. The controller 130 may be, for example, a central processing unit (CPU), or other programmable general-purpose or special-purpose microprocessor, digital signal processor (DSP), programmable controller, application specific integrated circuit (ASIC), programmable logic device (PLD), other similar devices, or combinations of these devices.

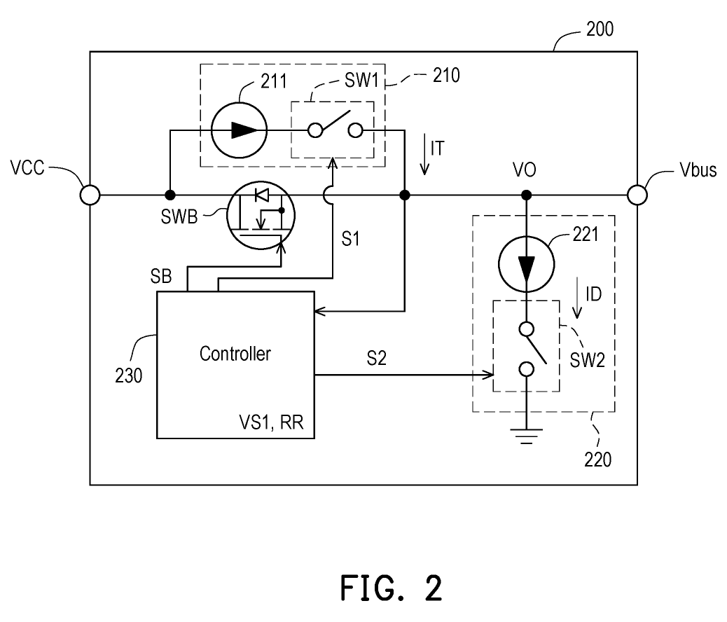

Referring to FIG. 2, FIG. 2 is a schematic diagram of the control circuit according to an embodiment of the disclosure. In this embodiment, a control circuit 200 includes a blocking switch SWB, a current source circuit 210, a discharge circuit 220, and a controller 230. The blocking switch SWB is electrically connected between a power supply terminal VCC and a bus power terminal Vbus. The current source circuit 210 includes a current source 211 and a switch SW1. The first terminal of the current source 211 is electrically connected to the power supply terminal VCC. The current source 211 generates a test current IT. The switch SW1 is electrically connected between the second terminal of the current source 211 and the bus power terminal Vbus. The discharge circuit 220 includes a current source 221 and a switch SW2. The first terminal of the current source 221 is electrically connected to the bus power terminal Vbus. The current source 221 generates a discharge current ID. The switch SW2 is electrically connected between the second terminal of the current source 221 and a reference low voltage.

In this embodiment, the controller 230 is electrically connected to the control terminal of the blocking switch SWB, the control terminal of the switch SW1, and the control terminal of the switch SW2. Before supplying power to the bus power terminal Vbus, the controller 230 turns off the blocking switch SWB, turns off the switch SW1, and turns on the switch SW2. Therefore, the output voltage value VO can be pulled down based on the discharge current ID.

When the output voltage value VO is lowered to the set voltage value VS1, the controller 230 turns off the blocking switch SWB, turns off the switch SW2, and turns on the switch SW1. Therefore, the test current IT is provided to the bus power terminal Vbus.

When the output voltage value VO is higher than the set voltage value VS2 during the period when the test current IT is provided to the bus power terminal Vbus, the controller 230 turns on the blocking switch SWB. In addition, the switch SW1 and the switch SW2 are turned off.

For example, the set voltage value VS1 and the set voltage value VS2 may be 0.8 V respectively, but the disclosure is not limited thereto. Therefore, before supplying power to the bus power terminal Vbus, the discharge circuit 220 pulls down the output voltage value VO at the bus power terminal Vbus to be lower than or equal to the set voltage value VS1. Next, during the period of providing the test current IT to the bus power terminal Vbus, when the output voltage value VO is higher than the set voltage value VS2, the controller 230 turns on the blocking switch SWB. Therefore, pulling down the output voltage value VO at the bus power terminal Vbus to be lower than or equal to the set voltage value VS1 can comply with the Vself0V specification.

In this embodiment, the set voltage value VS1 is the same as the set voltage value VS2. In some embodiments, the set voltage value VS2 may be different from the set voltage value VS1.

In this embodiment, the switch SW1 and the switch SW2 may be implemented by transistors of any type respectively.

In this embodiment, the current source 211 may be driven by the power supply at the power supply terminal VCC to generate the test current IT. The current source 221 is, for example, driven by the power supply at the power supply terminal VCC or the output voltage value VO at the bus power terminal Vbus to generate the discharge current ID.

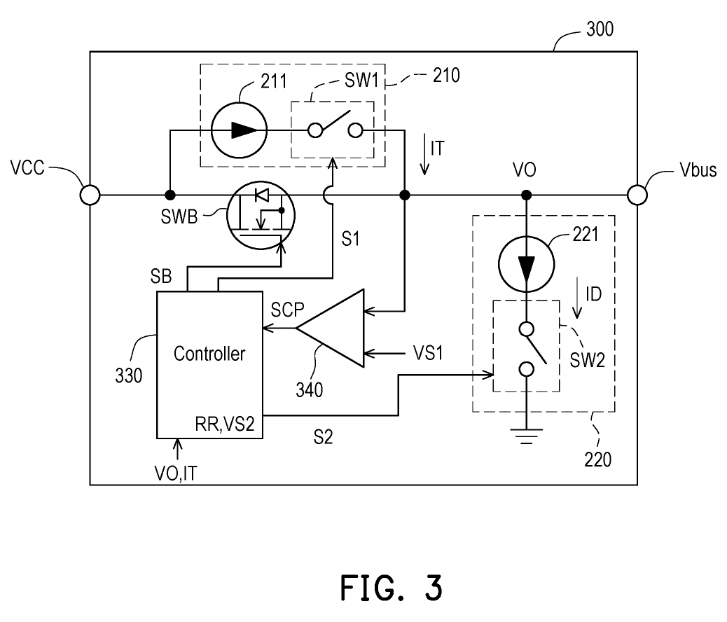

Referring to FIG. 3, FIG. 3 is a schematic diagram of the control circuit according to an embodiment of the disclosure. In this embodiment, a control circuit 300 includes a blocking switch SWB, a current source circuit 210, a discharge circuit 220, a controller 330, and a comparator 340. How to implement the blocking switch SWB, the current source circuit 210, and the discharge circuit 220 has been clearly described in the embodiment of FIG. 2, so the description will not be repeated here.

In this embodiment, the comparator 340 is electrically connected to the bus power terminal Vbus and the controller 330. The comparator 340 receives the output voltage value VO and the set voltage value VS1. Before supplying power to the bus power terminal Vbus, the comparator 340 compares the output voltage value VO and the set voltage value VS1 to generate a comparison signal SCP.

Before supplying power to the bus power terminal Vbus, the controller 330 receives the comparison signal SCP. When the comparison signal SCP indicates that the output voltage value VO is higher than the set voltage value VS1, the controller 330 controls the discharge circuit 220 to pull down the output voltage value VO, and controls the current source circuit 210 to stop providing the test current IT to the bus power terminal Vbus. When the comparison signal SCP indicates that the output voltage value VO is lower than or equal to the set voltage value VS1, the controller 330 controls the discharge circuit 220 to stop pulling down the output voltage value VO, and controls the current source circuit 210 to provide the test current IT to the bus power terminal Vbus.

For example, the first input terminal (for example, inverting input terminal) of the comparator 340 is electrically connected to the bus power terminal Vbus to receive the output voltage value VO. The second input terminal (for example, non-inverting input terminal) of the comparator 340 receives the set voltage value VS1. When the output voltage value VO is higher than the set voltage value VS1, the comparison signal SCP has a first value (for example, low voltage value, low logic value, or low current value). Therefore, the controller 330 turns off the switch SW1 and turns on the switch SW2 according to the first value.

On the other hand, when the output voltage value VO is lower than or equal to the set voltage value VS1, the comparison signal SCP has a second value (for example, high voltage value, high logic value, or high current value). Therefore, the controller 330 turns off the switch SW2 and turns on the switch SW1 according to the second value.

In this embodiment, the controller 230 uses the control signal SB to control the blocking switch SWB, uses the control signal S1 to control the switch SW1, and uses the control signal S2 to control the switch SW2.

In this embodiment, the comparator 340 is disposed outside the controller 330. In some embodiments, the comparator 340 may be disposed inside the controller 330.

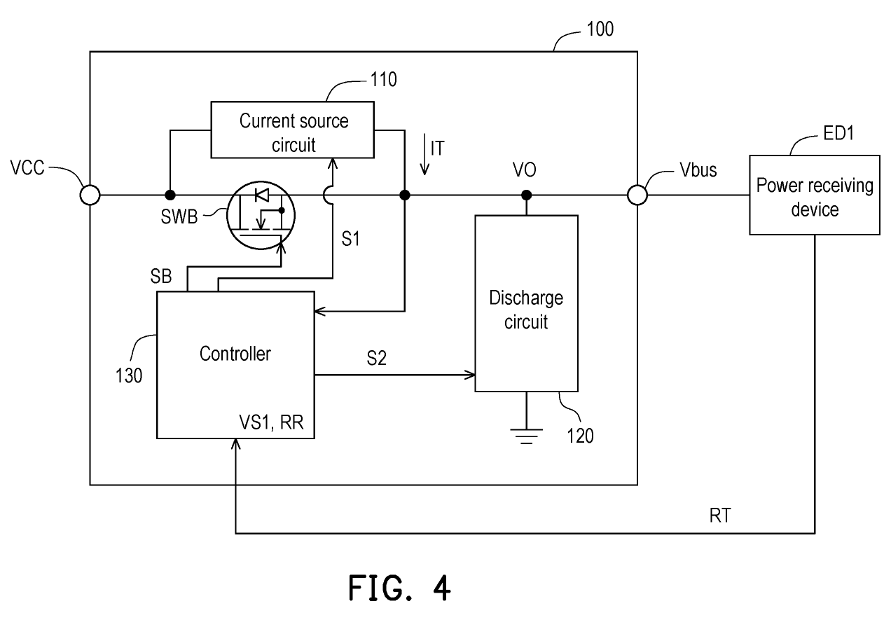

Referring to FIG. 1 and FIG. 4, FIG. 4 is an operational schematic diagram of the control circuit according to an embodiment of the disclosure. In this embodiment, a power receiving device ED1 is connected to the bus power terminal Vbus. The power receiving device ED1 may receive power through the bus power terminal Vbus of the USB. Before the USB supplies power to the bus power terminal Vbus (that is, before the USB starts to supply power to the power receiving device ED1), the control circuit 100 communicates with the power receiving device ED1 to obtain a communication resistance value RT. The controller 130 determines whether to control the current source circuit 110 to provide the test current IT to the bus power terminal Vbus according to the communication resistance value RT.

For example, the control circuit 100 may communicate with the power receiving device ED1 through a channel configuration (CC) pin to obtain the communication resistance value RT.

In this embodiment, the communication resistance value RT is the resistance value at the bus power terminal Vbus when the bus power terminal Vbus is connected to the power receiving device ED1. For example, when the communication resistance value RT is too low (for example, tens of Ohms), the control circuit 100 does not perform the detection operation of the resistance value at the bus power terminal Vbus before supplying power to the bus power terminal Vbus.

As another example, when the communication resistance value RT is sufficiently high, the control circuit 100 performs the detection operation of the resistance value at the bus power terminal Vbus before supplying power to the bus power terminal Vbus.

In this embodiment, the power receiving device ED1 may be any device that uses the USB to receive power.

In summary, before supplying power to the bus power terminal of the USB, the discharge circuit pulls down the output voltage value at the bus power terminal. When the output voltage value is pulled down to be lower than or equal to the set voltage value, the discharge circuit stops pulling down the output voltage value. The current source circuit provides the test current to the bus power terminal. The controller obtains the resistance value at the bus power terminal according to the output voltage value and the current value of the test current. In this way, before supplying power to the bus power terminal, the control circuit determines whether abnormal conditions such as low resistance value or short circuit occur at the bus power terminal according to the resistance value at the bus power terminal.

Although the disclosure has been described above with reference to the embodiments, they are not intended to limit the disclosure. Any person having ordinary knowledge in the art may make modifications and changes without departing from the spirit and scope of the disclosure. Therefore, the scope of protection of the disclosure shall be defined by the appended claims.

What is claimed is:

1. A control circuit for a universal serial bus, comprising:
a blocking switch electrically connected between a power supply terminal of the universal serial bus and a bus power terminal of the universal serial bus;
a current source circuit electrically connected between the power supply terminal and the bus power terminal;
a discharge circuit electrically connected between the bus power terminal and a reference low voltage; and
a controller electrically connected to a control terminal of the blocking switch, the current source circuit, and the discharge circuit,
wherein before supplying power to the bus power terminal, the controller turns off the blocking switch, and controls the discharge circuit to pull down an output voltage value at the bus power terminal,
wherein in response to the output voltage value being lower than or equal to a first set voltage value, the controller controls the discharge circuit to stop pulling down the output voltage value, and controls the current source circuit to provide a test current to the bus power terminal, and
wherein the controller obtains a resistance value at the bus power terminal according to the output voltage value and a current value of the test current.

2. The control circuit according to claim 1, wherein the current source circuit comprises:
a first current source, wherein a first terminal of the first current source is electrically connected to the power supply terminal, and the first current source is configured to generate the test current; and
a first switch electrically connected between a second terminal of the first current source and the bus power terminal.

3. The control circuit according to claim 2, wherein the discharge circuit comprises:
a second current source, wherein a first terminal of the second current source is electrically connected to the bus power terminal, and the second current source is configured to generate a discharge current; and
a second switch electrically connected between a second terminal of the second current source and the reference low voltage.

4. The control circuit according to claim 3, wherein before supplying power to the bus power terminal, the controller turns off the blocking switch, turns off the first switch, and turns on the second switch.

5. The control circuit according to claim 3, wherein in response to the output voltage value being lowered to the first set voltage value, the controller turns off the blocking switch, turns off the second switch, and turns on the first switch.

6. The control circuit according to claim 1, wherein during a period when the test current is provided to the bus power terminal, in response to the output voltage value being higher than a second set voltage value, the controller turns on the blocking switch.

7. The control circuit according to claim 1, further comprising:
a comparator electrically connected to the bus power terminal and the controller, and configured to receive the output voltage value and the first set voltage value,
wherein before supplying power to the bus power terminal, the comparator compares the output voltage value and the first set voltage value to generate a comparison signal.

8. The control circuit according to claim 1, wherein:
before supplying power to the bus power terminal, the controller receives a comparison signal, and
in response to the comparison signal indicating that the output voltage value is higher than the first set voltage value, the controller controls the discharge circuit to pull down the output voltage value, and controls the current source circuit to stop providing the test current to the bus power terminal.

9. The control circuit according to claim 8, wherein in response to the comparison signal indicating that the output voltage value is lower than or equal to the first set voltage value, the controller controls the discharge circuit to stop pulling down the output voltage value, and controls the current source circuit to provide the test current to the bus power terminal.

10. The control circuit according to claim 1, wherein:
the control circuit communicates with a power receiving device connected to the bus power terminal to obtain a communication resistance value, and
the controller determines whether to control the current source circuit to provide the test current to the bus power terminal according to the communication resistance value.
